(19) United States
(12) Patent Application Publication
(10) Pub. No.: US 2009/0219961 A1
(43) Pub. Date: Sep. 3, 2009

(54) Laser Systems and Methods Having Auto-Ranging and Control Capability

(75) Inventors: Brad E. Meyers, Issaquah, WA (US); David C. Shannon, Woodinville, WA (US); Scott Straka, Kirkland, WA (US)

Correspondence Address: Constellation Law Group, PLLC, P.O. Box 220, Tracyton, WA, 98393, US

(73) Assignee: B.E. MEYERS & CO., INC., Redmond, WA (US)

(21) Appl. No.: 12/039,715

(22) Filed: Feb. 28, 2008

(51) Int. Cl. H01S 3/13

(52) U.S. Cl. 372/29.01

(57) ABSTRACT

Laser systems and methods having an ability to automatically adjust a laser output based on one or more of a state of an object detected within a field of view and a motion of the laser system are disclosed.

### FIELD OF THE INVENTION

The present disclosure is directed to laser control systems, and more particularly, to laser systems and methods having an ability to automatically adjust a laser output based on a range to an object detected within a field of view to deliver a controlled exposure to the object.

### BACKGROUND OF THE INVENTION

Laser systems are used in a wide variety of civilian and military applications. Laser systems may be used, for example, for illuminating objects, determining distances (or ranging), detecting events, targeting objects, communications, and for a wide variety of other purposes. Recently, high-intensity laser illumination (or “dazzling”) has been used in various security-related applications (e.g. military checkpoints, border crossings, access control stations, etc.) and has proven to be an effective deterrent of potentially-hostile activity, thereby promoting stability and saving lives.

As is generally known, laser systems are not entirely without risk to human vision. Many applications require laser systems to be operated at power levels that may be considered detrimental to human vision. One generally-accepted criterion for assessing whether a laser is operating at a power level detrimental to human vision is known as the Nominal Ocular Hazard Distance (NOHD). Because the power density of a laser's output decreases with increasing distance from the laser due to beam spreading, a particular laser power level may be considered safe at longer ranges, but may become hazardous within a certain operating range near the laser. The NOHD defines a near-range exposure danger zone for human vision.

In many situations that involve relatively high power laser systems, protection protocols and systems have been developed that attempt to minimize harmful exposure to laser irradiation that may be detrimental to human vision. Such protocols and systems may include, for example, mandatory use of laser-safe goggles, laser beam enclosures (particularly within the NOHD), door-lock systems that automatically shut off laser systems upon entry, and various other safety measures. Although desirable results have been achieved, there are situations where the use of such conventional safety systems and protocols may be impractical or impossible.

### SUMMARY

The present disclosure teaches laser systems and methods having an ability to automatically determine a range to an object detected within a field of view, and to automatically adjust the laser (e.g. intensity, output power, divergence, etc.) to reduce a potential risk to the object. Embodiments of systems and methods in accordance with the teachings of the present disclosure may advantageously adjust the laser to deliver a specific exposure to the target, and thereby enhance the safety of laser operations in a variety of conditions and circumstances where conventional safety methods and protocols are impractical or impossible to implement. In some embodiments, an operator may control a desired effect the laser system will have on a target within a field of view (e.g. dazzle, hail, warn, etc.), while an auto-ranging and control capability of the laser system promotes safety by automatically adjusting the laser to control the exposure of the target to be less than a maximum permissible exposure (MPE).

### BRIEF DESCRIPTION OF THE DRAWINGS

Embodiments of the present disclosure are described in detail below with reference to the following drawings.

FIG. 1 is an exemplary environment having a laser system in a first operating condition in accordance with an embodiment of the present disclosure.

FIGS. 2-4 show the exemplary environment of FIG. 1 having the laser system in second, third, and fourth operating conditions, respectively.

FIG. 5 is a schematic view of the laser system of FIG. 1 in accordance with another embodiment of the present disclosure.

FIG. 6 is an exemplary laser power time history of the laser system of FIG. 5 in accordance with an alternate embodiment of the present disclosure.

FIG. 7 is a schematic view of a laser system in accordance with another alternate embodiment of the present disclosure.

FIG. 8 is an exemplary environment having a laser system in accordance with yet another embodiment of the present disclosure.

FIG. 9 is a process for operating a laser system in accordance with a further embodiment of the present disclosure.

FIG. 10 is a schematic view of a laser system in accordance with yet another embodiment of the present disclosure.

FIG. 11 is a table of some of the potential operating conditions that may be encountered by embodiments of laser systems in accordance with the present disclosure, including the laser system of FIG. 10.

FIG. 12 is a process for operating a laser system in accordance with another embodiment of the present disclosure.

### DETAILED DESCRIPTION

The present disclosure is directed to laser systems and methods having an ability to automatically adjust a laser output based on a range to an object detected within a field of view. Many specific details of certain embodiments in accordance with the present disclosure are set forth in the following description and in FIGS. 1-12 to provide a thorough understanding of such embodiments. One skilled in the art, however, will understand that the present invention may have additional embodiments, or that the invention may be practiced without several of the details described in the following description.

FIG. 1 is an exemplary environment 100 having a laser system 110 in accordance with an embodiment of the present disclosure. In a first operating condition 103, the laser system 110 directs a laser beam 120 along a beam axis 122 toward a target 102. The laser beam 120 may be a pulsed or non-pulsed laser beam 120. As depicted by the gradually-decreasing shading of the laser beam 120, an intensity (or power density) of the laser beam 120 generally decreases with increasing distance from the laser system 110 (e.g. due to beam spreading, absorption, etc.). At least part of the laser beam 120 that impinges on the target 102 is reflected as target reflections 124 (specular or non-specular) from the target 102. In the first operating condition 103, an intermediate object 104 (e.g. a bystander) is positioned generally outside of the laser beam 120.

Although the exemplary environment 100 shown in FIG. 1 depicts the target 102 as a vehicle, it will be appreciated that in alternate embodiments, the target 102 may be any type of object (military or civilian) that may be illuminated with the laser system 110, including a person, a building, a natural landscape, a watercraft, an aircraft, or any other suitable object. Similarly, the laser beam 120 may be configured for a variety of purposes, including, for example, to illuminate the target 102, to “dazzle” the target 102 (or occupants thereof), to “hail,” “warn,” or “disrupt” the target 102, for targeting or aiming a weapon system (not shown), for inflicting damage on the target 102, or for any other suitable purpose.

In the embodiment shown in FIG. 1, the laser system 110 includes a laser source 112 and a beam directing assembly 114 that cooperatively generate and condition the laser light that ultimately forms the laser beam 120. A ranging system 150 is configured to determine a distance (or range) D_{T} to the target 102. A control system 116 is configured to transmit control signals to one or more of the other components of the laser system 110, including the laser source 112 and the beam directing assembly 114. The control system 116 is also configured to receive signals from one or more of the other components of the laser system 110, including the ranging system 150. In some embodiments, the laser system 110 also includes a power source 118 (e.g. a battery), such as may be desired for a portable laser system, however, in alternate embodiments, the laser system 110 may rely on an external power source (not shown).

The ranging system 150 may be based on a variety of conventional ranging methods and techniques. For example, in some embodiments, the ranging system 150 may be configured to receive at least a portion of the target reflections 124 from the target 102, and may include a time-of-flight (TOF) system that clocks the time required for a portion of the laser beam 120 (e.g. a laser pulse) emitted by the laser system 110 to travel to the target 102, reflect from the target 102, and travel back to the ranging system 150, given by:

Time=(2D_{T}/cₐᵢᵣ)=6.681 nsec/m (1)

where cₐᵢᵣ is the speed of light through air, and D_{T} is a distance between the laser system 110 and the target 102 (or target distance). Thus, the target distance D_{T} may be determined by:

D_{T}=(Time cₐᵢᵣ)/2=0.1497 m/nsec (2)

In alternate embodiments, the ranging system 150 may be based on other suitable ranging methods, including triangulation, modulation, or any other ranging technologies. In further embodiments, the ranging system 150 need not be based on any portion of the laser beam 120 (e.g. a laser pulse), but rather, may be independent from the laser beam 120. For example, in some embodiments, the ranging system 150 may be based on sonic (or acoustic) signals, ultrasonic signals, non-laser light signals, including signals from any suitable portion of the electromagnetic spectrum, imaging technologies, or even various non-signal-based technologies for determining range and distance (e.g. Global Positioning System technologies, physical contact sensors, etc.). Representative examples of suitable ranging technologies that may be used by the ranging system 150 include, but are not limited to, those technologies generally described in U.S. Pat. No. 7,317,872 issued to Posa et al., U.S. Pat. No. 7,271,761 issued to Natsume et al., U.S. Pat. No. 7,075,625 issued to Abe, U.S. Pat. No. 7,154,591 issued to Muenter, U.S. Pat. No. 6,697,146 issued to Shima, and U.S. Pat. No. 5,336,899 issued to Nettleton et al.

With continued reference to FIG. 1, a standoff distance D_{S} is shown. The standoff distance D_{S} may depend on various factors of the environment 100, such as the operating conditions and purpose of the laser beam 120, the range and identity of the target 102, the presence and identity of the bystander 104, or any other factors. In some embodiments, for example, the standoff distance D_{S} may be based on a desire to avoid a potential hazard to human vision. More specifically, the standoff distance D_{S} may be approximately equal to (or based on) a Nominal Ocular Hazard Distance (NOHD). The NOHD may be defined as a distance from the laser system 110 where a maximum permissible exposure (MPE) for human vision is exceeded. Of course, in alternate embodiments, other criterion for establishing the standoff distance D_{S} may be used. For example, because non-human species (e.g. animals, insects, etc) may have a visual acuity or sensitivity that is different from humans, the standoff distance D_{S} may be established based on an ocular hazard distance for such non-human species. Alternately, the standoff distance D_{S} may be established based on maximum exposure limits of nearby machines, sensors, electronics, or other systems, or may be established based on factors that are unrelated to vision (e.g. non-ocular factors).

In some embodiments, operation of the laser system 110 may begin by activating the laser system 110 to provide the laser beam 120 directed toward the target 102 to perform the desired functionality. The standoff distance D_{S} may be established by the operating conditions of the laser system 110, and may initially be assumed to compare favorably with the target distance D_{T}. The ranging system 150 may then determine the target distance D_{T}, either simultaneously or sequentially with the generation of the laser beam 120.

The laser system 110 may then compare the target distance D_{T} with the standoff distance D_{S} (e.g. using the control system 116). If the target distance D_{T} compares favorably with the standoff distance D_{S} (e.g. target distance D_{T} exceeds standoff distance D_{S}), the laser system 110 may continue providing the laser beam 120 without making any adjustments to the laser system 110. Alternately, if the target distance D_{T} compares unfavorably with the standoff distance D_{S} (e.g. target distance D_{T} does not exceed standoff distance D_{S}), the laser system 110 may perform adjustments to the operating conditions of the laser system 110 (and thus the standoff distance D_{S}) until a favorable comparison is achieved.

More specifically, in some embodiments, the laser system 110 (e.g. using the control system 116) may controllably adjust one or more portions of the laser system 110 to adjust the laser beam 120, and thus the standoff distance D_{S}, until the target distance D_{T} meets or exceeds the standoff distance D_{S}. For example, the control system 116 may adjust an output power of the laser source 112, or one or more portions of the beam directing assembly 114 (e.g. beam conditioning optics, attenuators, etc.), or both the laser source 112 and the beam directing assembly 114, to adjust the standoff distance D_{S}. In further embodiments, other portions of the laser system 110 may be adjusted to provide a desired standoff distance D_{S}. As operations continue, the laser system 110 may continue to monitor the target distance D_{T}, and continue to controllably adjust the laser operating conditions so that the standoff distance D_{S} continues to compare favorably with (e.g. less than) the target distance D_{T}.

In some embodiments, the laser system 110 may begin operating in a different way. More specifically, the operation of the laser system 110 may begin by having the ranging system 150 determine the target distance D_{T} (e.g. by “pinging” the target 102). Based on the target distance D_{T}, the laser system 110 may initiate the laser beam 120 so that the target distance D_{T} compares favorably with the standoff distance D_{S}. For example, in some embodiments, the standoff distance D_{S} may be established based on a desire to avoid potential hazards to human vision. In such cases, the standoff distance D_{S} may be based on the NOHD, and the laser system 110 may controllably generate the laser beam 120 so that the standoff distance D_{S} is less than (or equal to) the target distance D_{T}.

In still other embodiments, the operating conditions may be set so that the standoff distance D_{S} may initially assume a reasonably small value. The laser system 110 may then be operated to generate and direct the laser beam 120 toward the target 102, and the ranging system 150 may be operated, either simultaneously or sequentially with the presence of the laser beam 120, to determine the target distance D_{T}. The laser system 110 (e.g. via the control system 116) may determine whether the target distance D_{T} compares favorably or unfavorably with the standoff distance D_{S}, and may perform adjustments to laser beam 120 accordingly.

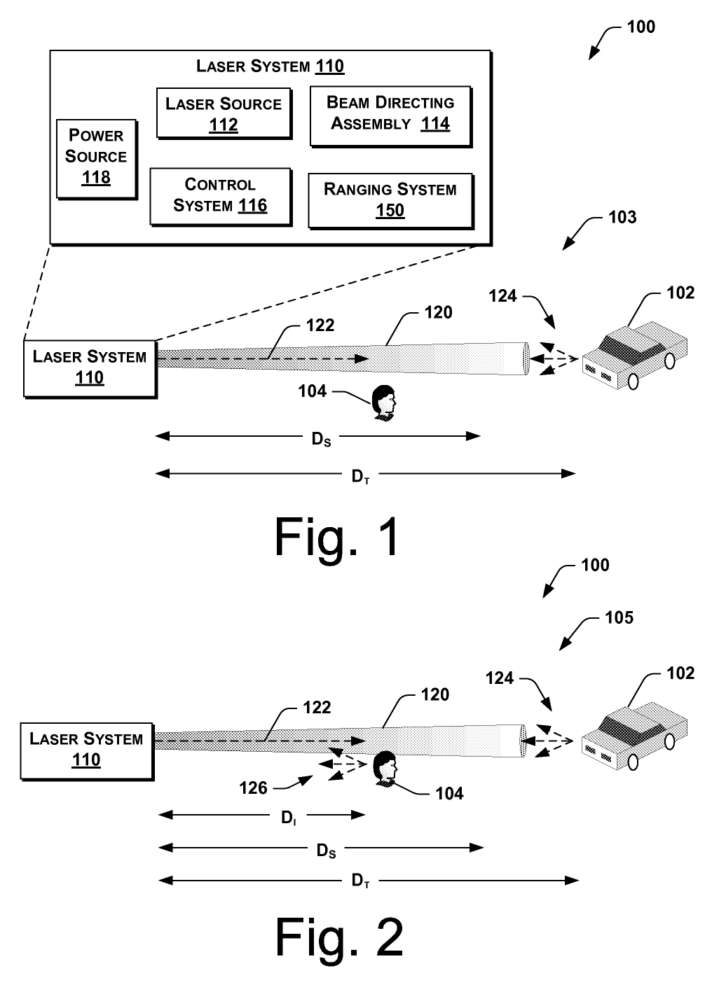

FIG. 2 shows the laser system 110 in a second operating condition 105 wherein the intermediate object (or bystander) 104 has recently moved into the laser beam 120. In the second operating condition 105, at least part of the laser beam 120 that impinges on the intermediate object 104 is reflected as intermediate reflections 126. The ranging system 150 automatically determines an intermediate distance D_{I} between the laser system 110 and the intermediate object 104, and the control system 110 compares the intermediate distance D_{I} with the standoff distance D_{S}. In the second operating condition 105 shown in FIG. 2, the intermediate distance D_{I} is less than the standoff distance D_{S}, and thus compares unfavorably with the standoff distance D_{S}. More specifically, in some embodiments, the bystander 104 has entered the NOHD portion of the laser beam 120 (i.e. the near-range exposure danger zone for human vision).

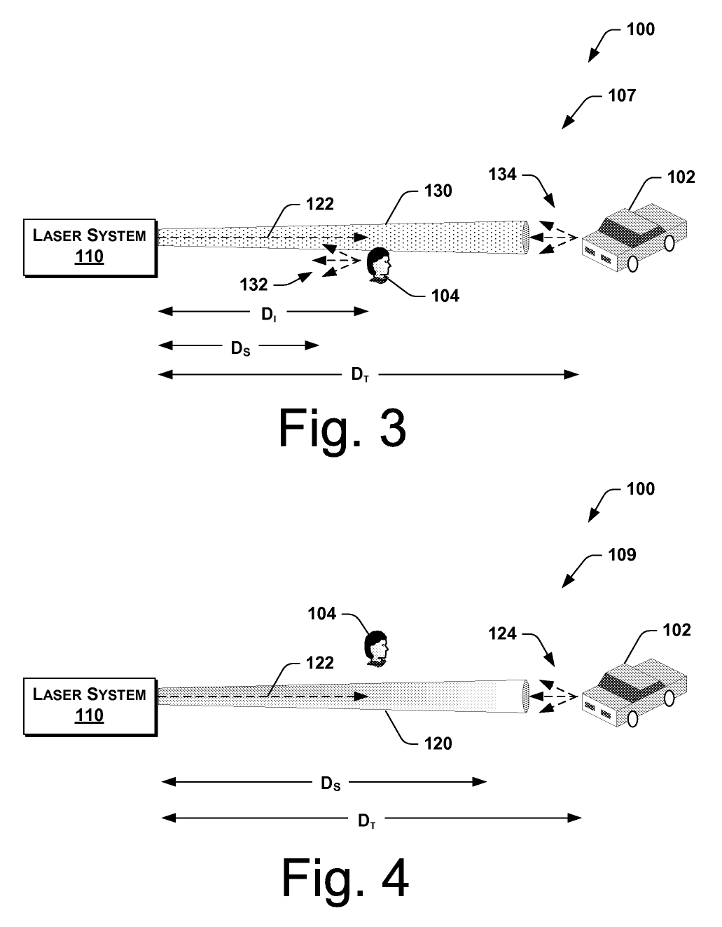

In a third operating condition 107 shown in FIG. 3, the laser system 110 has automatically adjusted the standoff distance D_{S} based on the presence of the intermediate object 104. More specifically, the laser system 110 has automatically adjusted one or more portions of the laser system 110 to provide an adjusted laser beam 130 such that the intermediate distance D_{I} meets or exceeds the standoff distance D_{S}. Although the third operating condition 107 shown in FIG. 3 depicts that laser system 110 as providing the adjusted laser beam 130, it will be appreciated that in some embodiments, it may be necessary to completely shut down the laser system 110 in the third operating condition 107 so that the intermediate distance D_{I} compares favorably with the standoff distance D_{S}.

In a fourth operating condition 109 shown in FIG. 4, the bystander 104 has moved out of the laser beam 130. The ranging system 150 automatically determines that the bystander 104 is no longer within the laser beam 130 (or other specified field-of-view), and that the closest object within the laser beam 130 is once again the target 102. Based on the target distance D_{T}, the laser system 110 automatically adjusts the laser beam 120 (and thus the standoff distance D_{S}) back to the initial operating condition 103. In the fourth operating condition 109, the laser system 110 continues to provide the laser beam 120 to perform the desired function, and may continue to monitor and adjust the operating conditions so that the target distance D_{T} compares favorably with the standoff distance D_{S}.

Embodiments of systems and methods in accordance with the present disclosure may provide substantial advantages over conventional laser systems. For example, systems and methods having an ability to automatically adjust a laser output based on a range to an object detected within a field of view may promote safety in a wider range of operating environments in comparison with conventional systems. Because such systems may automatically detect the presence of an intermediate object, and may automatically adjust the laser system to ensure that the intermediate object is outside the standoff distance, embodiments in accordance with the present disclosure may enhance the safety of laser operations in a variety of conditions and circumstances where conventional safety methods and protocols are impractical or impossible to implement. Embodiments in accordance with the present disclosure may also enhance the safety of laser operations at substantially-reduced cost, and with improved reliability, in comparison with conventional alternatives.

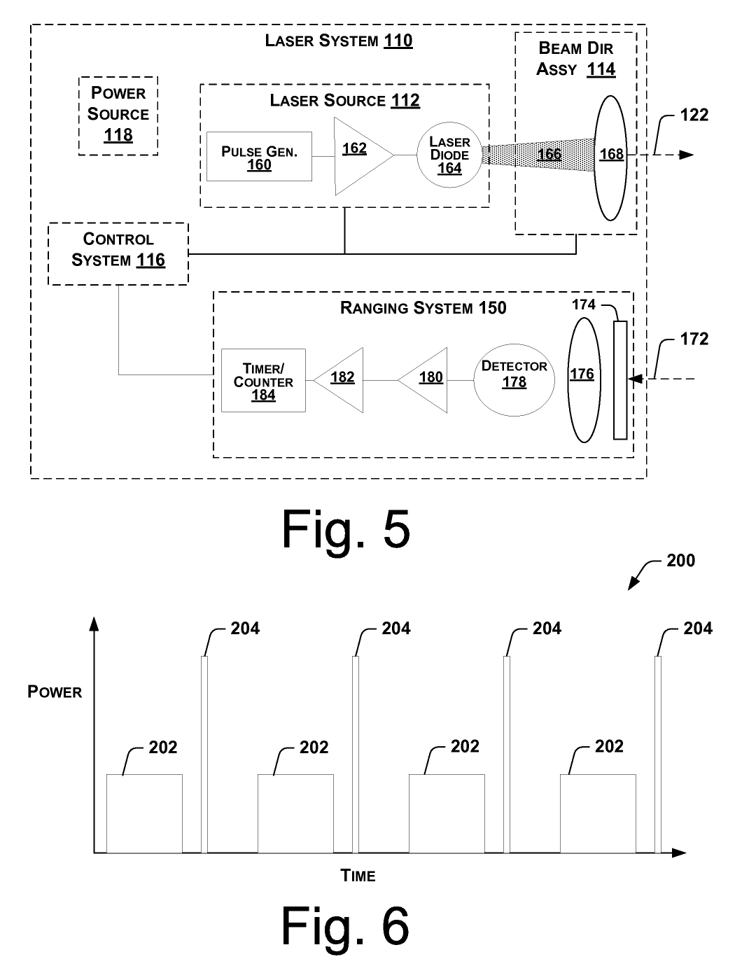

It will be appreciated that a variety of suitable embodiments of the laser system 110 may be conceived that provide the desired operability in accordance with the teachings of the present disclosure. For example, FIG. 5 is a schematic view of one possible embodiment of the laser system 110 of FIG. 1. In this embodiment, the laser source 112 includes a pulse generator 160 coupled to a laser driver 162. A laser diode 164 is driven by the laser driver 162 to provide a laser light 166 to the beam directing assembly 114. One or more conditioning optics 168 of the beam directing assembly 114 condition the laser light 166 to provide a collimated laser beam along the beam axis 122.

In some implementations, the components of the laser system 110 may be configured to provide a pulsed laser light 166 at controlled current levels. For example, the pulses of laser light 166 may be adjustably varied within a range of approximately 10 nsec to approximately 50 nsec. Of course, in alternate embodiments, pulses of any other suitable duration may be employed.

With continued reference to FIG. 5, in this embodiment, the ranging system 150 receives a reflected portion 172 of the emitted laser beam that reflects from the distal target 102 or the intermediate object 104. The reflected portion 172 passes through an optical bandpass filter 174 and one or more conditioning optics 176 of the ranging system 150 before impinging upon a detector 178. In some embodiments, the detector 178 may include a photodiode, an avalanche photodiode, a photo-detector, or any other suitable detection device. Output signals from the detector 178 may be conditioned by an amplifier 180 and by an automatic gain control (AGC) component 182. The AGC component 182 conditions the output signals so that, despite variations in the input level (e.g. the reflected portion 172), the average level of the output from the AGC component 182 are approximately at a predetermined value (or within a predetermined range). A timer (or counter) 184 receives the output signals from the AGC component 182 and determines the target distance D_{T} using, for example, Equation (2) above.

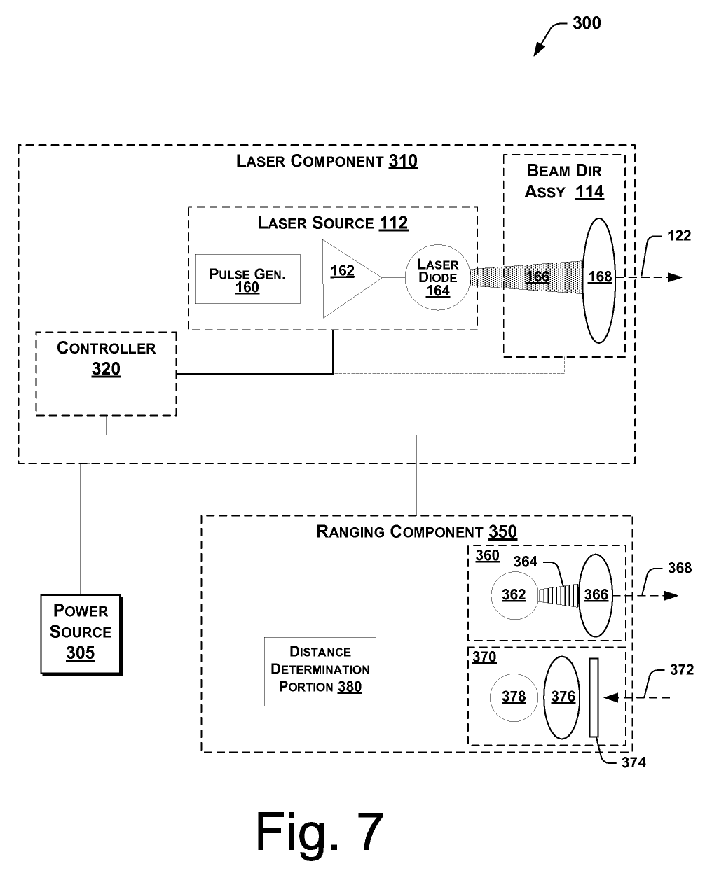

FIG. 6 is an exemplary laser power time history 200 of the laser system 110 of FIG. 5. In this embodiment, the time history 200 includes a series of alternating illumination pulses 202 and ranging pulses 204. The ranging pulses 204 are of higher intensity and shorter duration than the illumination pulses 202, and are configured to operate as the source of the reflected signals 172 received by the ranging system 150. Similarly, the illumination pulses 202 are configured to perform the intended purpose of the laser system 110 with respect to the target 102 (e.g. illuminate, “dazzle,” aim, damage, etc.).

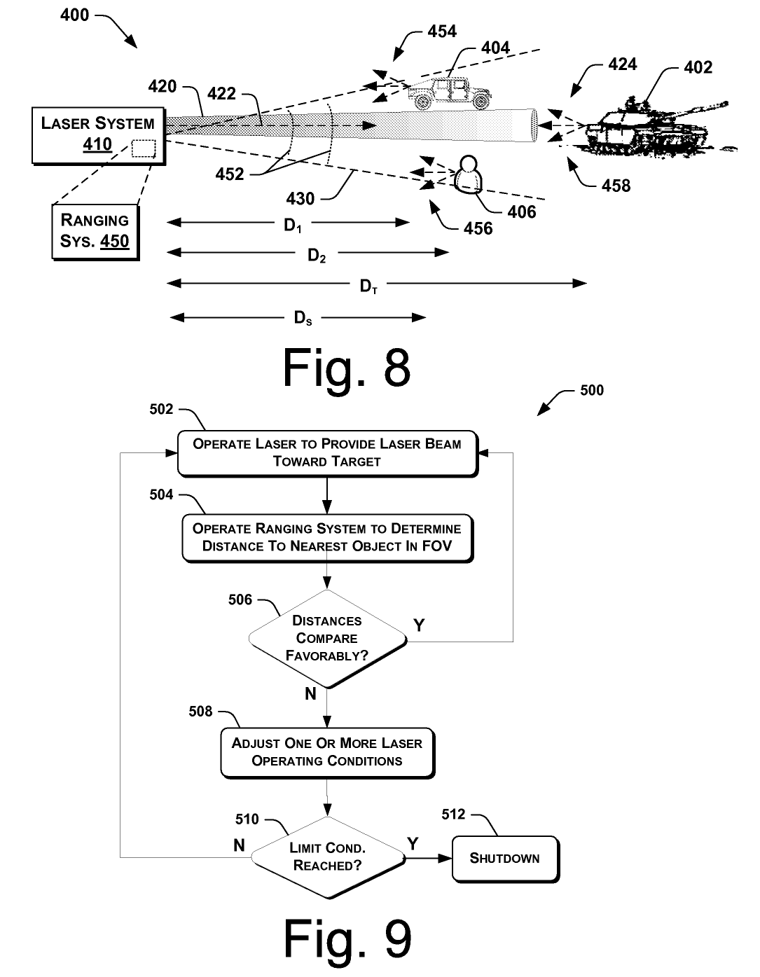

FIG. 7 is a schematic view of a system 300 in accordance with another alternate embodiment of the present disclosure. In this embodiment, the system 300 includes a laser component 310 and a ranging component 350 powered by an external power source 305. The laser component 310 includes a laser source 112 and a beam directing assembly 114 having substantially the same structural components and functionality as described above with respect to FIG. 5. A controller 320 controls the laser source 112 and the beam directing assembly 114 to provide a laser output 122 toward a distal target (not shown).

The ranging component 350 is operatively coupled to the laser component 310 and includes a signal generation portion 360, a signal detection portion 370, and a distance determination portion 380. In this embodiment, the signal generation portion 360 includes a source 362 that emits signals 364 into a signal conditioner 366. A ranging signal 368 is transmitted from the signal generation portion 360 toward a distal object within a field of view of the ranging component 350.

As further shown in FIG. 7, a portion of the ranging signal 368 is reflected back from the distal object as a return signal 372. The return signal 372 passes through a first signal conditioner 374 (e.g. a filter), a second signal conditioner 376 (e.g. focusing optics), and arrives to a detector 378. The distance determination portion 380 receives an output from at least the signal detection portion 370 and determines the range to the distal object. The ranging component 350 outputs the range to the laser component 310 (e.g. to the controller 320), and continues performing ranging of distal objects within the field of view. Thus, the above-described advantages of laser systems and methods having an ability to automatically determine a range to an object detected within a field of view, and to automatically adjust the laser (e.g. illumination intensity, etc.) to reduce a potential risk to the object, may be achieved using a system 300 having separate laser and ranging components 310, 350 that cooperatively perform the desired functionality.

FIG. 8 is an exemplary environment 400 having a laser system 410 that includes a ranging system 450 in accordance with yet another embodiment of the present disclosure. The laser system 410 directs a laser beam 420 along a beam axis 422 toward a target 402. At least part of the laser beam 420 that impinges on the target 402 is reflected as target reflections 424 (specular or non-specular) from the target 402 back toward the laser system 410.

In this embodiment, the ranging system 450 monitors for the presence of objects within a field of view 430 that is larger than (and substantially inclusive of) the laser beam 420. For example, in addition to the target 402, a first intermediate object 404 (e.g. a vehicle) and a second intermediate object 406 (e.g. a person) are situated at least partially within the field of view 430. Both intermediate objects 404, 406 are outside the laser beam 430.

Ranging signals 452 are emitted by the ranging system 450 within the field of view 430. First reflected signals 454 are reflected from the first intermediate object 404, second reflected signals 456 are reflected from the second intermediate object 406, and target reflected signals 458 are reflected from the target 402. The ranging system 450 receives at least a portion of the reflected signals 454, 456, 458, and determines a first distance D₁ to the first intermediate object 404, a second distance D₂ to the second intermediate object 406, and a target distance D_{T} to the target 402. These distances may then be compared with a standoff distance Dₛ, and necessary adjustments (if any) may be made, as described above.

Embodiments of systems and methods in accordance with the present disclosure having a ranging system that operates using a field of view that is larger than an associated laser beam may provide additional advantages. Because the field of view extends laterally beyond the laser beam, the laser system may detect intermediate objects, and make necessary adjustments to the laser beam, before the intermediate objects actually enter the laser beam. This aspect may be a valuable aspect in some applications, particularly for relatively high power laser applications.

FIG. 9 is a process 500 for operating a laser system in accordance with a further embodiment of the present disclosure. In this embodiment, the process 500 includes operating a laser system to provide a laser beam toward a target at 502. The operating conditions of the laser system establish a standoff distance. At 504, a ranging system is operated to determine a distance to a nearest object within a field of view (FOV). In some embodiments, the field of view is coincident with the laser beam. Alternately, the field of view may be larger than the laser beam. The ranging system may be operated simultaneously or sequentially with the laser system. In some embodiments, the ranging system provides its own ranging signals, while in other embodiments, the ranging system uses reflected laser light generated by the laser system.

At 506, the process 500 determines whether the distance to the nearest object within the field of view compares favorably with the standoff distance. For example, in some embodiments, the standoff distance is based on the NOHD portion of the laser beam (i.e. the near-range exposure danger zone for human vision), and the distance to the nearest object compares favorably when it is greater than the standoff distance, and compares unfavorably when it is not greater than the standoff distance. If the comparison is favorable (at 506), then the process 500 returns to 502 and continues performing the above-noted activities indefinitely (502 through 506).

On the other hand, if the distance to the nearest object within the field of view compares unfavorably with the standoff distance (at 506), then the process 500 adjusts one or more of the laser operating conditions at 508. For example, in some embodiments, a control system may controllably adjust one or more of a laser source and a beam directing assembly in order to adjust a standoff distance of the laser beam.

Next, after performing the adjustment at 508, the process 500 may determine whether a limit condition has been reached at 510. For example, the process 500 may determine whether some type of lower (or minimum) operating limit has been reached on a laser operating condition (e.g. output power, divergence angle, etc.) so that continued operation of the laser is no longer practical or suitable for its intended purpose. If the determination at 510 is affirmative, the process 500 proceeds to shutdown at 512. Alternately, if no limit condition has been reached (at 510), then the process 500 returns to 502, and continues performing the above-described actions (502 through 510) indefinitely.

It will be appreciated that the process 500 is one possible implementation in accordance with the present disclosure, and that the present disclosure is not limited to the particular process implementations described herein and shown in the accompanying figures. For example, in alternate implementations, certain acts need not be performed in the order described, and may be modified, and/or may be omitted entirely, depending on the circumstances. Moreover, in various implementations, the acts described may be implemented by a computer, controller, processor, programmable device, or any other suitable device, and may be based on instructions stored on one or more computer-readable media or otherwise stored or programmed into such devices. In the event that computer-readable media are used, the computer-readable media can be any available media that can be accessed by a device to implement the instructions stored thereon.

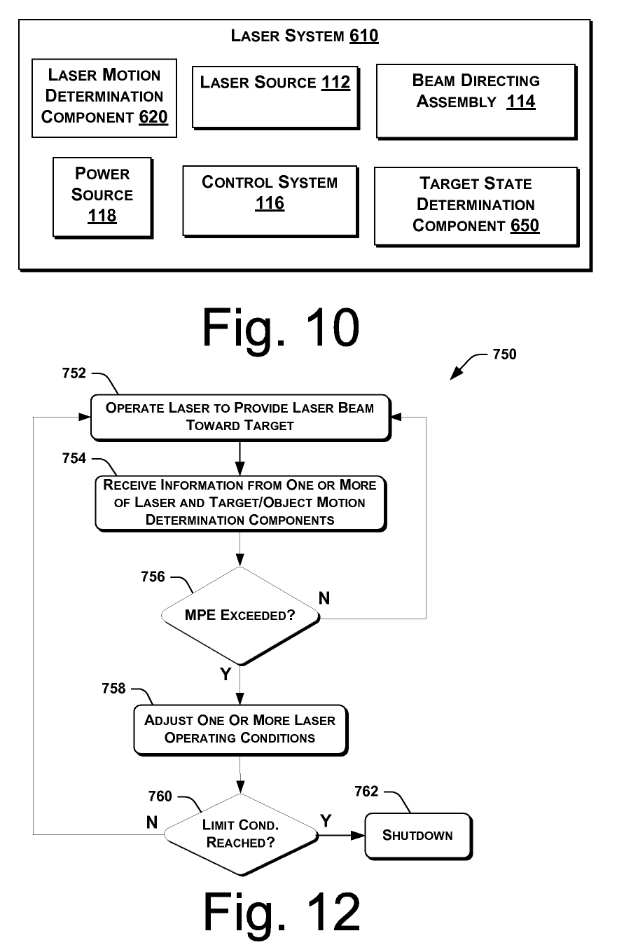

Embodiments of systems and methods in accordance with the present disclosure may be configured to operate while the laser system is moving, the objects within the field of view are moving, or both. For example, FIG. 10 is a schematic view of a laser system 610 in accordance with still another embodiment of the present disclosure. The laser system 610 includes many of the same components as the laser system 110 described above with reference to FIG. 1 (e.g. laser source 112, beam directing assembly 114, control system 116, power source 118). In this embodiment, however, the laser system 610 includes a laser motion determination component 620 and a target state determination component 650.

The laser motion determination component 620 may be configured to monitor and detect motion of the laser system 610 in one or more of the customary six-degrees of freedom of motion, including one or more of the translational motion components (e.g. x, y, and z axis) and the rotational motion components (e.g. roll, pitch, and yaw). The laser motion determination component 620 may include a variety of known components (e.g. accelerometers, gyroscopes, GPS devices, etc.) for sensing one or more components of the translational and/or rotational motion of the laser system 610. The information collected by the laser motion determination component 620 may then be provided to the control system 116.

More specifically, in some embodiments, the laser motion determination component 620 may include a single or multi-axis accelerometer or gyroscope to detect motion of the laser system 610, and may be configured to automatically adjust, attenuate, or even shut-down the laser system 610 until motion of the beam has slowed to the point where the target state determination component 650 (or other rangefinder part of the system) has time to acquire the target and obtain a valid range estimate. For example, in some particular embodiments, the state determination (or rangefinder) component may have a range acquisition rate within a range of approximately 10's to 100's of Hz, while the motion of the beam at 100+ meters while swinging the beam around could be extremely fast (100+ m/s). This scenario could address the ‘horseplay’ problem where users in the field are swinging the lasers around and not controlling/aiming them properly like a weapon.

Similarly, the target state determination component 650 may be configured to determine the range (or distance) D_{T} to targets or objects within the field of view of the laser system 610 as described above, and may also be configured to determine one or more aspects of the motion of such targets or objects. For example, using known techniques and technologies, including those described above for determining range (e.g. time-of-flight, triangulation, modulation, etc.), the target state determination component 650 may determine one or more components of the target's translational motion (e.g. velocities along x, y, and z axis). In further embodiments, the target state determination component 650 may be configured to determine the range and one or more components of the customary six degrees-of-freedom of motion of the target (or object), including translational motion components and rotational motion components if desired. The target state determination component 650 may then provide such target state information to the control system 116.

The control system 116 is configured to receive information from the laser motion determination component 620 and the target state determination component 650, to assess whether the target has reached the maximum permitted exposure (MPE) level for the particular operating conditions, and if necessary, to transmit appropriate control signals to one or more of the other components of the laser system 110 (e.g. laser source 112, beam directing assembly 114, etc.) to adjust one or more operating conditions of the laser system 610 to ensure that the MPE level is not exceeded.

For example, in some embodiments, the laser motion determination component 620 may provide information to the control system 116 regarding the translational and rotational motion of the laser system 610, while the target state determination component 650 provides information to the control system 116 regarding the range and translational motion (but not rotational motion) of the targets and objects within the field of view of the laser system 610. In other embodiments, the laser motion determination component 620 provides information to the control system 116 regarding the translational and rotational motion of the laser system 610, while the target state determination component 650 provides only ranging (or distance) information to the control system 116 regarding the targets and objects within the field of view. In still other embodiments, one of the components 620, 650 may be omitted entirely, and the control system 112 may receive information from the remaining one of the components 620, 650. Of course, in still other embodiments, both of the components 620, 650 may provide any desired combination of information regarding the six degrees-of-freedom of the laser system 610 and the range and motion of the targets and objects within the field of view. The control system 112 is configured with suitable control logic (e.g. software, hardware, firmware, or combinations thereof) to use the information received from the one or more components 620, 650, and to provide appropriate control signals to adjust one or more operating conditions of the laser system 610 (e.g. intensity, output power, divergence, attenuation, wavelength, complete shutdown, etc.) as desired. For example, the control system 112 may be configured to adjust the laser system 610 to ensure that the MPE level is not exceeded. Alternately, the control system 112 may be configured to adjust the laser system 610 to react a certain way for certain operating scenarios. For example, in a particular embodiment, if a target is approaching the laser system, an adjustment of the laser system may be made (e.g. the modulation rate or power level could be automatically increased) to warn the target, or to perform any other desired function.

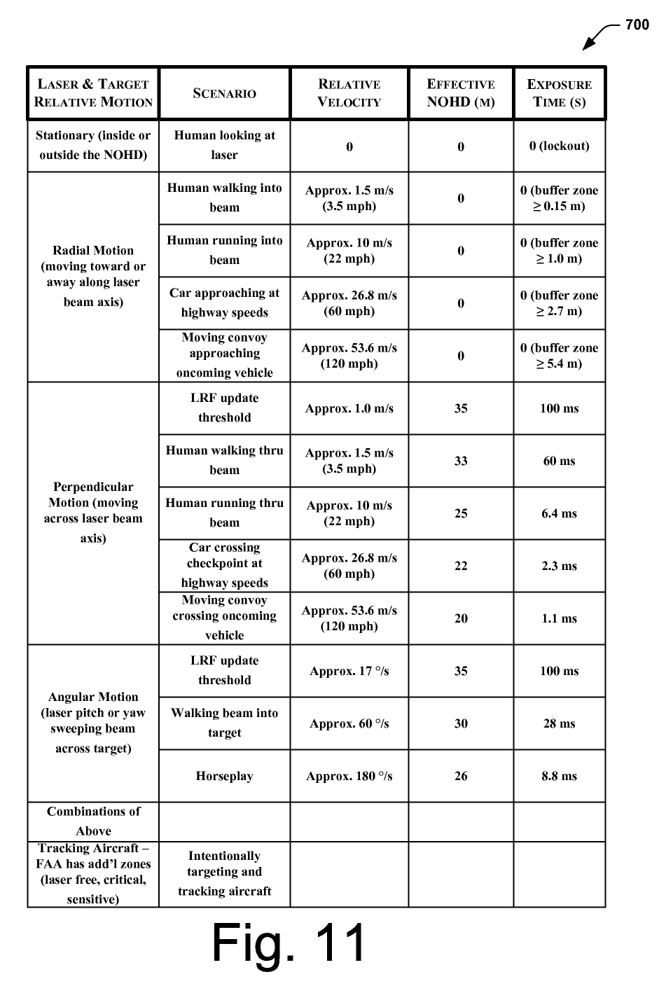

FIG. 11 is a table 700 of some of the potential operating conditions that may be encountered by embodiments of laser systems in accordance with the present disclosure, including the laser system 610 of FIG. 10. For example, as shown in the column entitled “Laser & Target Relative Motion,” embodiments of the present disclosure may encounter one or more of the following possible operating conditions: stationary laser system and target, radial motion (moving toward or away along laser beam axis); perpendicular motion (moving across laser beam axis), angular motion (laser pitch or yaw sweeping beam across target), combinations of the above conditions, and tracking aircraft.

Under the column entitled “Scenario,” the table 700 provides a few representative scenarios that may be encountered for each category of “Laser & Target Relative Motion.” For example, for the “Stationary” category, a possible scenario includes a human looking at the laser. For the “Radial Motion” category, the table 700 shows possible scenarios including a human walking into the laser beam, a human running into the laser beam, a car approaching the laser at highway speeds, and a moving convoy approaching an oncoming vehicle. Similarly, for the “Perpendicular Motion” category, the possible scenarios include an LRF (Laser Range Finder) update threshold, a human walking through (or across) the laser beam, a human running through (or across) the laser beam, a car crossing a checkpoint at highway speeds, and a moving convoy crossing an oncoming vehicle. For the “Angular Motion” category, the table 700 shows possible scenarios including an LRF update threshold, walking beam into target, and “horseplay” (e.g. erratic movement of the laser beam by an operator for amusement).

For each combination of the above-listed categories and scenarios, the table 700 also provides exemplary values for relative velocity (translational and rotational), effective NOHD, and exposure time. Of course, it will be appreciated that the table 700 is merely representative of some possible operating conditions, and is not exhaustive of all possible operating conditions that may be experienced by embodiments of methods and systems in accordance with the present disclosure.

FIG. 12 is a process 750 for operating a laser system in accordance with another embodiment of the present disclosure. In this embodiment, the process 750 includes operating a laser system to provide a laser beam toward a target at 752. At 754, a control system receives information from one or more of a laser motion determination component and a target/object state determination component. As described above, in various alternate embodiments, the control system may receive information from either the laser motion determination component or the target/object state determination component, or both, and one or both of the components may provide any desired combination of information regarding the six degrees-of-freedom and ranges of the laser system and the targets/objects within the field of view. In some embodiments, the field of view is coincident with the laser beam. Alternately, the field of view may be larger than the laser beam. The motion and state determination components may be operated simultaneously or sequentially with each other and with the laser system. In some embodiments, the target state determination component provides its own sensing signals, while in other embodiments, the target state determination component uses reflected laser light generated by the laser system, or any other source of state determination signals (e.g. GPS signals, contact sensors, images, etc.).

At 756, the process 750 analyzes the information received at 754 and determines whether the maximum permissible exposure has been exceeded for any of the one or more targets and objects within the field of view. For example, with reference to the table 700 shown in FIG. 11, some of the objects and targets within the field of view may be stationary with respect to the laser system, while others may be moving radially, perpendicularly, or angularly with respect to the laser system. If it is determined that the MPE has not been exceeded (at 756), then the process 750 returns to 752 and continues performing the above-noted activities indefinitely (752 through 756).

On the other hand, if the MPE has been exceeded (at 756), then the process 750 adjusts one or more of the laser operating conditions at 758. For example, in some embodiments, a control system may controllably adjust one or more characteristics of the laser system (e.g. a laser source, a beam directing assembly, etc.) in order to adjust one or more characteristics of the laser beam (e.g. intensity, output power, divergence, attenuation, wavelength, complete shutdown, etc.).

After performing the adjustment at 758, the process 750 may optionally determine whether a limit condition has been reached at 760. For example, the process 750 may determine whether some type of lower (or minimum) operating limit has been reached on a laser operating condition (e.g. output power, divergence angle, etc.) so that continued operation of the laser is no longer practical or suitable for its intended purpose. If the determination at 760 is affirmative, the process 750 may proceed to a shutdown at 762 or any other suitable activity. Alternately, if no limit condition has been reached (at 760), then the process 750 may return to 752, and may continue performing the above-described actions (752 through 760) indefinitely.

Embodiments of systems and methods having capabilities to determine the state and/or motion of the laser system and/or the target (or both) may provide significant advantages. Because such embodiments are able to determine the translational and rotational motions of the laser system and target, as well as range to the target, such embodiments may be better able to perform the desired functionality over a broader range of operating conditions. For example, such embodiments may be better able to provide the desired auto-control capabilities when one or more of the objects and targets within the field of view are moving radially, perpendicularly, or angularly with respect to the laser system. Such embodiments may even provide improved capability to perform the desired functionality during off-design conditions such as horseplay by the operator, or bumping, dropping, or other accidental movement of the laser system. Thus, embodiments of systems and methods in accordance with the present disclosure may advantageously enhance the safety of laser operations in a variety of conditions and circumstances where conventional safety methods and protocols are impractical or impossible to implement.

The detailed descriptions of the above embodiments are not exhaustive descriptions of all embodiments contemplated by the inventors to be within the scope of the invention. Indeed, persons skilled in the art will recognize that certain elements of the above-described embodiments may variously be combined or eliminated to create further embodiments, and such further embodiments fall within the scope and teachings of the invention. It will also be apparent to those of ordinary skill in the art that the above-described embodiments may be combined in whole or in part to create additional embodiments within the scope and teachings of the present disclosure. Accordingly, the scope of the invention should be determined from the following claims.

What is claimed is:

1. An apparatus, comprising:
a laser system configured to emit a beam;
a state determination component configured to analyze a field of view at least one of coincident with and substantially encompassing the beam and to determine at least an object distance between the laser system and an object within the field of view; and
a control system configured to receive target state information from the state determination component, and to determine whether a maximum permissible exposure has been exceeded, and to controllably adjust one or more operating conditions of the laser system based on the determination.

2. The apparatus of claim 1 wherein the state determination component is configured to determine the object distance based on a portion of the beam that is reflected from the object to the state determination component.

3. The apparatus of claim 1 wherein the state determination component is configured to transmit a ranging signal toward the object and to determine the object distance based on a portion of the ranging signal that is reflected from the object to the state determination component.

4. The apparatus of claim 1 wherein the beam comprises a series of laser pulses, and wherein the state determination component is configured to determine the object distance based on a reflected portion of at least some of the series of laser pulses.

5. The apparatus of claim 1 wherein the laser system is configured to emit a beam having a standoff distance, and wherein the control system is configured to determine whether the maximum permissible exposure has been exceeded based on a comparison of the object distance with the standoff distance.

6. The apparatus of claim 5 wherein the control system is further configured to controllably adjust one or more operating conditions of the laser system to adjust the standoff distance to ensure a favorable comparison between the object distance and the standoff distance.

7. The apparatus of claim 6 wherein the standoff distance is based on a nominal ocular hazard distance, and wherein the object distance compares favorably with the standoff distance when the object distance exceeds the standoff distance.

8. The apparatus of claim 1 wherein the laser system includes a laser source that generates a laser light, and a beam directing assembly that conditions the laser light into the beam.

9. The apparatus of claim 8 wherein the control system is configured to controllably adjust one or more of the laser source and the beam directing assembly.

10. The apparatus of claim 1 wherein the state determination component includes at least one signal conditioner that conditions incoming ranging signals, a detector that senses incoming ranging signals, an automatic gain control component that conditions an output from the detector, and a processor that determines the object distance based on the output of the automatic gain control component.

11. The apparatus of claim 1 wherein the state determination component is configured to determine the object distance based on one or more of a time of flight method, a triangulation method, and a modulation method.

12. The apparatus of claim 1 wherein the laser system includes a laser motion determination component that provides laser motion information to the control system, and wherein the control system is configured to determine whether a maximum permissible exposure has been exceeded based on the laser motion information and the target state information.

13. The apparatus of claim 12 wherein the laser motion information includes laser rotational information, and wherein the target state information further includes target translational motion information.

14. A method, comprising:
providing a laser beam;
determining a state of an object within a field of view at least one of coincident with and substantially encompassing the laser beam;
determining whether a maximum permissible exposure of the object has been exceeded; and
if the maximum permissible exposure has been exceeded, automatically adjusting one or more operating conditions of the laser beam.

15. The method of claim 14 wherein determining a state of an object includes determining an object distance based on a portion of the laser beam that is reflected from an object.

16. The method of claim 14 wherein determining a state of an object includes transmitting a ranging signal toward the object, and determining the object distance based on a portion of the ranging signal that is reflected from the object.

17. The method of claim 14 wherein providing a laser beam includes providing a series of laser pulses, and wherein determining a state of an object distance includes determining an object distance based on a reflected portion of at least some of the series of laser pulses.

18. The method of claim 14 wherein providing a laser beam includes providing a laser beam having an intensity configured to at least one of dazzle, warn, and disrupt a distal observer.

19. The method of claim 14 wherein automatically adjusting one or more operating conditions of the laser beam includes automatically adjusting one or more of a laser output power, an intensity, an attenuation, and a divergence angle of the laser beam.

20. The method of claim 14 wherein the laser beam has a standoff distance, and wherein determining whether a maximum permissible exposure of the object has been exceeded includes comparing the state of the object with the standoff distance.

21. The method of claim 20 wherein the state of the object includes an object distance and the standoff distance is based on a nominal ocular hazard distance, and wherein the object distance compares favorably with the standoff distance when the object distance exceeds the standoff distance.

22. The method of claim 14 wherein determining a state of an object includes determining an object distance based on one or more of a time of flight method, a triangulation method, and a modulation method.

23. The method of claim 14, wherein determining a state of an object includes determining at least one an object distance, a translational motion, and a rotational motion of the object.

24. The method of claim 14, further comprising determining a motion of the laser system, and wherein determining whether a maximum permissible exposure of the object has been exceeded includes determining whether a maximum permissible exposure of the object has been exceeded based on the motion of the laser system and the state of the object.

25. The method of claim 14, wherein determining a state of an object includes determining a range and a translational motion of the object, the method further comprising determining a rotational motion of the laser system, and wherein determining whether a maximum permissible exposure of the object has been exceeded includes determining whether a maximum permissible exposure of the object has been exceeded based on the rotational motion of the laser system and the range and translational motion of the object.

26. An assembly, comprising:
a laser system configured to emit a laser beam;
at least one of a laser motion determination component configured to determine a laser motion information, and a target state determination component configured to determine a target state information of at least one object within a field of view; and
a control system configured to receive at least one of the laser motion information and the target state information, and to determine an exposure level of the object to the laser beam, and to controllably adjust one or more operating conditions of the laser system based on the determination.

27. The assembly of claim 26 wherein the at least one of the laser motion determination component and the target state determination component includes both the laser motion determination component and the target state determination component.

28. The assembly of claim 27 wherein the laser motion information includes one or more of a laser translational motion and a laser rotational motion, and wherein the target state information includes one or more of a target distance, a target translational motion, and a target rotational motion.

29. The assembly of claim 27 wherein the laser motion information includes a laser rotational motion, and wherein the target state information includes a target distance and a target translational motion.

30. The assembly of claim 26 wherein the control system is configured to controllably adjust one or more operating conditions to prevent a maximum permissible exposure from being exceeded.
